(19) United States
(12) Patent Application Publication
(10) Pub. No.: US 2020/0349603 A1
(43) Pub. Date: Nov. 5, 2020

(54) SYSTEMS AND METHODS FOR MEMBERSHIP APPLICATION WITH RETAILERS

(71) Applicant: Walmart Apollo, LLC, Bentonville, AR (US)

(72) Inventors: Vinod Suresh, Fremont, CA (US); Balasubramonian S. Prasanna, Bentonville, AR (US); Richard W. Deaton, Bentonville, AR (US); Ravi Kiran Songa, Bentonville, AR (US); Amin Vatani, Santa Clara, CA (US); Thilak Bhaskaran Sriram, Bentonville, AR (US)

(21) Appl. No.: 16/864,420

(22) Filed: May 1, 2020

Related U.S. Application Data
(60) Provisional application No. 62/841,805, filed on May 1, 2019.

(51) Int. Cl. G06Q 30/02; G06Q 50/26

(52) U.S. Cl. CPC G06Q 30/0236; G06Q 50/265; G06Q 30/0226

(57) ABSTRACT

In some embodiments, apparatuses and methods are provided herein pertaining to membership applications with retailers. In some embodiments, system for membership application with a retailer, the system comprising a control circuit configured to process applications for membership and credit with the retailer, the retailer offering memberships allowing customers to be able to purchase products and receive benefits pertaining to membership; a capture device configured to obtain an image of the customer and electronically scan data from a customer identification card for automatic population into an electronic membership application; a user interface device configured to facilitate an application process; a retailer server to communicate with a financial institution server configured to process an electronic credit application received from the membership processing control circuit. The control circuit populates the membership and credit applications with the captured data, processes the membership application and outputs the credit application to the financial institution server.

### CROSS-REFERENCE TO RELATED APPLICATION

This application claims the benefit of U.S. Provisional Application No. 62/841,805 filed May 1, 2019, which is incorporated herein by reference in its entirety.

### TECHNICAL FIELD

This invention relates generally to memberships with retailers and, more particularly, the application process for retailer membership programs.

### BACKGROUND

Retailers often offer memberships for customers to provide customers with access to member privileges and pricing, and to help ensure customer purchasing consistency and loyalty. For example, a customer may apply for an annual membership with a retailer allowing the customer to purchase items with the retailer during the period of the membership. A typical membership application process at a brick and mortar retailer may involve a physical visit of the customer to the retailer's facility and manually filling out a membership application which is then manually input into the retailer's system by employees of the retailer for processing. Once processed and accepted, the customer is issued a membership card that is presented on entry to physical retail facilities and at a point of sale and/or to enable online purchases.

### BRIEF DESCRIPTION OF THE DRAWINGS

Disclosed herein are embodiments of systems, apparatuses, and methods pertaining to automating membership and/or credit applications with retailers. This description includes drawings, wherein:

FIG. 1 is a functional system block diagram of a system for use with customers applying for membership programs and/or credit with a retailer according to some embodiments;

FIG. 2 is a simplified flow diagram of an exemplary retailer membership application process according to some embodiments;

FIG. 3 is a simplified flow diagram of an exemplary process of screening a potential member for credit or loyalty options according to some embodiments;

FIG. 4 is a simplified flow diagram of an exemplary credit application process for a potential member according to some embodiments;

FIG. 5 is a flow diagram of an exemplary membership application process using a mobile user device according to some embodiments;

FIGS. 6 and 7 are screen shots illustrating a flow diagram of an exemplary membership application process using a mobile user device according to some embodiments;

FIG. 8 is a flow diagram of an exemplary membership application process using at a kiosk according to some embodiments;

FIGS. 9 and 10 are screen shots illustrating a flow diagram of an exemplary enterprise membership application process according to some embodiments; and

FIGS. 11A-11F are exemplary screen shots of exemplary membership application process according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to customers applying for membership and/or credit or other benefits with retailers.

In some embodiments, a system and method for membership application with a retailer is provided, the system comprising a membership processing control circuit configured to process applications for membership and credit with the retailer, the retailer offering memberships allowing customers to be able to purchase products and receive benefits pertaining to membership; a capture device coupled to the membership processing control circuit and configured to obtain an image of the customer and electronically scan data from a customer identification card for automatic population into an electronic membership application; a user interface device comprising a display and an input device coupled to the membership processing control circuit, wherein the user interface device is configured to facilitate an application process; and a retailer server coupled to the membership processing control circuit and configured to communicate with a financial institution server configured to process an electronic credit application received from the membership processing control circuit. The user interface device is configured to prompt the customer to pose for the capture device to obtain the image of the customer; to prompt the customer to present the customer identification card to the capture device for automatic capturing of customer data from the customer identification card; and prompt the customer to input additional data for the electronic credit application. The membership processing control circuit is configured to receive, from the capture device, the image of the customer and the customer data captured from the customer identification card; populate the electronic membership application and the electronic credit application with the customer data and the additional data; process the electronic membership application; transmit the electronic credit application to the financial institution server via the retailer server; receive data from the financial institution server indicating an acceptance and terms of a credit offer based on the electronic credit application; and output to the user interface device an approval of the electronic membership application and the credit offer and the terms for presentation to the customer.

In some embodiments, a method for membership application with a retailer comprises: prompting, using a user interface device comprising a display and an input device, a customer to pose for an image to be obtained by a capture device; prompting, using the user interface device, the customer to present a customer identification card to the capture device; automatically capturing, using the capture device, the image of the customer and customer data read from the customer identification card; receiving, at a membership processing control circuit coupled to the user interface device and the capture device, the image of the customer and the customer data captured from the customer identification card, the membership processing control circuit configured to process applications for membership and credit with the retailer, the retailer offering memberships allowing customers to be able to purchase products and receive benefits pertaining to membership; prompting the customer to input additional data for an electronic credit application using the user interface device; populating an electronic membership application and the electronic credit application with the customer data and the additional data; processing the electronic membership application; transmitting the electronic credit application to a financial institution server via a retailer server coupled to the membership processing control circuit, wherein the financial server is configured to process the electronic credit application; receiving data from the financial institution server via the retailer server indicating an acceptance and terms of a credit offer based on the electronic credit application; and outputting to the user interface device an approval of the electronic membership application and the credit offer and the terms for presentation to the customer.

A typical membership application process can be inconvenient and time consuming for customers. Often, the process involves the manual filling out of application forms to provide prospective member data, such as name, address, etc. Member applications may be filled out using pen and paper forms or electronically entered data. Manually or electronically entered data can be prone to customer error if not entered correctly. This data is often then re-entered by the retailer employee into the retailer's system, introducing another delay and potential error point. Further, a customer may wish to apply for credit or other benefit with the retailer apart from the membership process. Such credit application process similarly may involve the manual completion of customer data into forms, and the manual re-entry of this data into the retailer's system. In accordance with some embodiments, the membership application process can be made significantly faster by allowing capture devices such as optical scanners or cameras to optical read and scan a customer's identification card, such as a state issued driver's license, passport or other card issued by a governmental authority. Often such identification cards include optically or electromagnetically readable devices, such as 2D or 3D optical barcodes, or radio frequency identification (RFID) or near field communication (NFC) devices. Data pertaining the customer, such as full name, address, etc. is encoded into these readable devices. When scanned or read by an input device at the membership application process, the steps of inputting customer data into the system is automated, less prone to error and considerably faster. Some membership applications and other credit applications may require more information about a customer, such as a social security number, income information, etc. If such data is contained in the readable code, chip or device on the customer's identification, such data can also be read and input into the system. Alternatively, this additional information may be input by the user or the retailer employee electronically or on paper to complete the application process. By getting the data needed for the application process input into the system quickly and reliably in an automated fashion by scanning or reading the customer's identification card, the process is more efficient. With the data entered into the system, the application process can be managed by the computer system, and can lead to increased customer adoption of other electronic programs that may be offered by the retailer, such as auto-renew programs, scan and purchase programs, auto/recur purchase programs, etc. A typical membership and credit application can process can take 10-15 minutes or longer, and in some embodiments, the entire process of membership application and credit application can be reduced to less than one minute. This can result in shorter membership lines and wait times, and greater customer satisfaction.

Customers may apply for membership in a variety of ways. In some embodiments, customers may interact with an employee of the retailer at a traditional membership desk having their identification card scanned or read by the employee executing the application process. In some embodiments, customers perform a self-application process at a kiosk located in the retailer facility or a free-standing kiosk outside of the retailer facility, in which the customer uses the user interface of the kiosk and scanner/reader of the kiosk to enter the data and complete the process. In some embodiments, customers can scan a QR code to activate the process from a browser or download an application (“app”) to their mobile user device (e.g., mobile phone, tablet or other user device) that will guide the user through the application process including using the built-in camera or RFID/NFC reader of the user device to retrieve the customer data from the identification card. The populated application may then be transmitted to a server for processing, or may be transmitted to a kiosk or membership counter at the retail facility. In some embodiments, customers can apply online using a computer or other device that has the ability capture an image of the identification card or otherwise allow for uploading a user-obtained image of the card.

In the event payment is required to complete a membership, a payment or credit card of the member can be optically or electronically scanned or input into the system and processed.

In some embodiments, some jurisdictions may have restrictions over the ability of the retailer to scan or read customer data from the customer's identification card. For example, some states restrict the ability to scan the barcode of a user's state issued driver's license. For example, some states do not allow a retailer to scan such data, some states require that the user be the one to hold the card up to the scanner/reader and some have no restrictions. In the application process, in some embodiments, prior to scanning/reading a user's card, the system will first prompt the user for the state issuing the card, then the process may change based on the laws of that state, i.e., the customer may be prompted to provide consent or the employee may be required to turn the scanner to the customer and let the customer scan the card instead of the employee. To the extent there are such restrictions, some embodiments may require customer consent to capture the information from the identification card as a part of the application process. In such a process, consent may be obtained, from the user, via the application process. The application process may ensure compliance with the appropriate privacy laws for the location where the application is taken. No unauthorized collection of customer data of individuals occurs via exemplary systems and methods.

The processing of credit applications may require the approval from third party financial institutions, such as by Synchrony Financial Services Company. Customer data read/scanned from identification cards and any additional information such as social security number, income information is transmitted from the retailer computer/server to the third party server for processing. The third party will process the request and provide back approved credit offer/s and associated terms.

In some embodiments, membership and/or credit approvals and terms are communicated to customers, e.g., on the user interface of the membership desk, the kiosk, the mobile application, the mobile device, the computer, and so on. Actual or temporary membership and/or credit cards may be issued onsite (e.g., by activate pre-printed card) to hand to members, or picked up at a pickup location, or mailed to the member. Activated membership cards can be ready for immediate use.

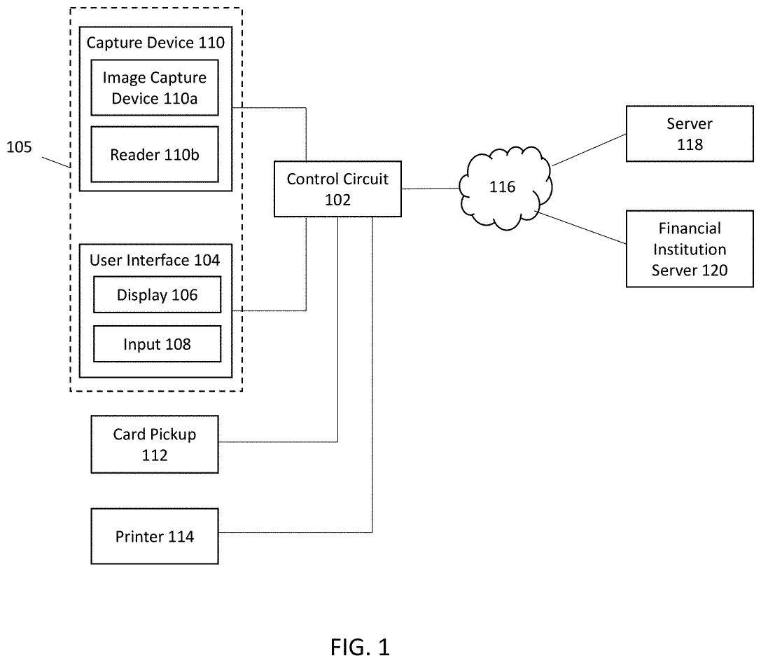

Referring first to FIG. 1, a functional system block diagram illustrates a system for use with customers applying for membership programs and/or credit with a retailer according to some embodiments. A control circuit 102 (e.g., a membership processing control circuit) runs and manages the application process and is coupled to a capture device 110 and a user interface device 104 including a display 106 and an input 108. The control circuit 102 can also communicate with retailer server/s 118 and third party servers, such as financial institution server/s 120 via a computer network 116. Additionally, the control circuit 102 is coupled to a card pickup 112 and an optional printer 114.

Generally, the control circuit 102 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 102 is configured (for example, by using corresponding programming as will be well understood by those skilled in the art) to carry out one or more of the steps, actions, and/or functions described herein.

By one optional approach the control circuit 102 operably couples to a memory. The memory may be integral to the control circuit 102 or can be physically discrete (in whole or in part) from the control circuit 102 as desired. This memory can also be local with respect to the control circuit 102 (where, for example, both share a common circuit board, chassis, power supply, and/or housing) or can be partially or wholly remote with respect to the control circuit 102 (where, for example, the memory is physically located in another facility, or metropolitan area, as compared to the control circuit 102). This memory can serve, for example, to non-transitorily store the computer instructions that, when executed by the control circuit 102, cause the control circuit 102 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The network 116 can be of any suitable type. For example, the network 116 can be a local area network (LAN) and/or a wide area network (WAN) such as the internet. Accordingly, the network 116 can include wired and/or wireless links.

In some embodiments, the capture device 110 comprises an image capture device 110a and/or a reader 110b. In some embodiment, the image capture device Ila is a device that can optically capture an image of the identification card, such as a digital camera. The device 110a can be equipped to capture images of 2D or 3D optical barcodes. In some embodiments, the capture device 110 comprises a reader 110b configured to electromagnetically read data from electromagnetically readable devices such as RFID (radio frequency identification) or NFC (near field communication) devices. For example, the reader 110b could be an RFID or NFC reader.

The user interface device 104 may be variously implemented. In some embodiments, the user interface 104 is provided at an employees' computer terminal at a membership counter. In other embodiments, the user interface 104 is implemented at a kiosk at or outside of a store or other location. In other embodiments, the user interface 104 is implemented at a user device, such as by a user's smartphone, tablet or other mobile electronic device. In other embodiments, the user interface 104 is implemented at a user's computer accessing the control circuit 102 via the computer network 116. It is understood that in some embodiments, the capture device 110 (or electromagnetic reader) and the user interface device 104 are implemented at the same device, such as the user's smart phone or tablet, e.g., as illustrated in dashed box 105.

It is noted that while not illustrated, the user interface 104 and/or capture device 110 may likewise include a suitable control circuit to control operation of the respective device. For example, in the event a user's mobile device is the capture device 110 and the user interface 104, the user's device will likely include an application stored in the memory of the device and executed by the control circuit or otherwise activated using a browser, e.g., by scanning a code or selecting to initiate.

It is also noted that in some embodiments, the capture device 110 (or electromagnetic reader) and the user interface 104 may be separate and remote from the control circuit 102, e.g., a mobile location, at a user's home, outside of a retailer location, or at a kiosk location such that there is not a direct connection to the control circuit. It is understood that in some embodiments, the connection to the control circuit 102 from the device 110 and user interface 104 can be wired or wireless, direct or indirect, or via the network 116 or other wide or local area network, using any number of known communication protocols. In some embodiments, the capture device 110 and the user interface device 104 are integrated into a device containing the membership processing control circuit.

In some embodiments, the retailer server 118 contains a larger database of membership data and requirements, point of sale systems, etc. that may be accessed by the control circuit as needed. Further, the control circuit 102 will communicate credit applications to the financial institution server 120, and receive responses and offers.

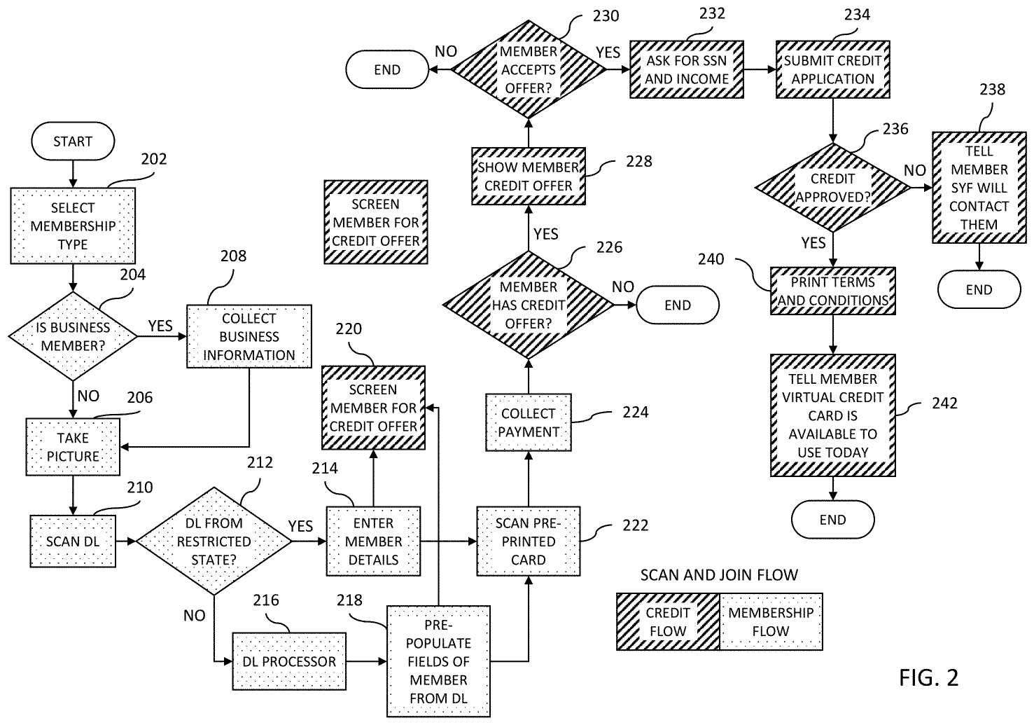

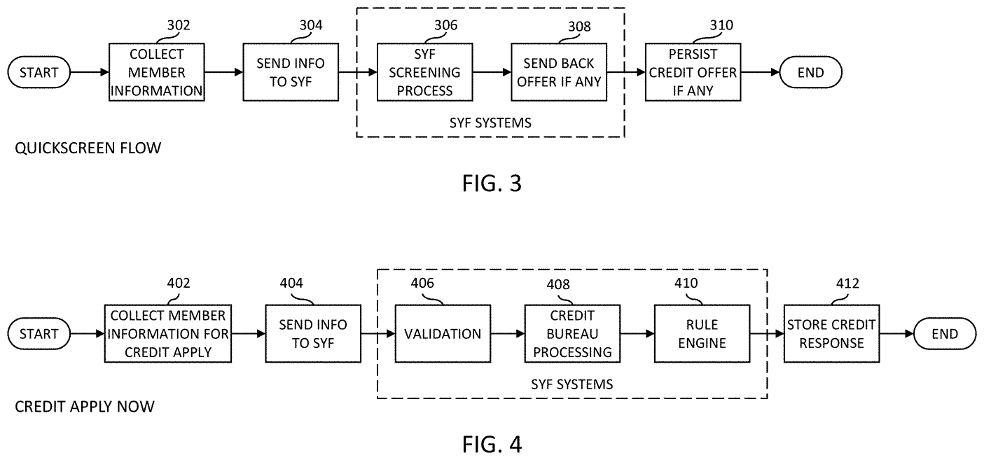

Referring next to FIG. 2, a simplified flow diagram is shown of an exemplary retailer membership application process according to some embodiments. The membership application process can be initiated in several ways, e.g., interacting with an employee of the retailer, using a user interface and scanning a code using the capture device or otherwise selecting an option to indicate an intent to apply for a membership. As illustrated the process starts by selecting the membership type (202). If the type is not for a business, a picture of the user is taken (206), e.g., the customer is prompted to pose for the capture device to obtain the image of the customer. If for a business (204), business information is collected (208), e.g., from business card, and then a picture is taken of the user (206). Next, the user's identification card is scanned (210) or otherwise the data is scanned or read as described herein. In some embodiments, if the identification card is from a restricted state (212), the user data is manually entered (214). If not (212), the driver's license process causes the data from the card to be scanned and obtained from the images captured or data electromagnetically captured (216) and the application/s is pre-populated with the data (218). Next, after 214 and 218, the member is screened for possible credit offers (220) as described in more detail in FIG. 3. Also, a pre-printed membership card is scanned (222). In some cases, the user interface displays instructions for the customer to retrieve the membership card having been scanned, encoded or printed for the customer. Membership payment is collected (224). The process ends if there are no credit offers (226). It is noted that step 212 may occur prior to step 210 such that if the license is from a restricted state, the process may direct the user how to scan the card or not allow the user to scan the card. If there are credit offers (226), the credit offer is displayed to the member (228). The process ends if the member declines the offer (230). If the member is interested (230), the member is prompted for additional information needed for the credit application (232), such as social security number, income information, job history, etc. The electronic credit application is then submitted to the financial institution server (234) such as described in more detail in FIG. 4. If the credit is not approved (236), the member is informed and will be contacted by the institution to provide reasons (238). If the credit is approved (236), the offer and terms are provided to the member (240), e.g., printed or displayed for the member. Next, the member is informed that a virtual credit card is available for immediate use (242) and a physical card will later be delivered to the member.

Referring next to FIG. 3, a simplified flow diagram is shown of an exemplary process of screening a potential member for credit or loyalty options according to some embodiments. This example flow diagram is an expansion of step 220 in FIG. 2. Initially, member information is collected (302) and then transmitted to the financial institution server (304). The financial provider performs an initial screening process (306) and transmits any offers available (308) back to the control circuit 102. The offer is presented to the member (310) to determine if the member is interested.

Referring next to FIG. 4, a simplified flow diagram is shown of an exemplary credit application process for a potential member according to some embodiments. This example flow diagram is an expansion of step 234 in FIG. 2. Initially, member information and any additional information needed for the credit application is collected (402) and then transmitted to the financial institution server (404). The financial provider validates the data received (406), obtains credit bureau data (408) and applies rules to determine if the credit will be approved (410). The response is transmitted back to the control circuit 102 and presented to the member (412).

It is understood that many of the steps in FIGS. 2-4 may be performed by the system and devices of FIG. 1 and/or those other systems and components described herein. In some embodiments, by automatically capturing or reading the customers information from an identification card, the entire process is accelerated and less error prone. It is noted that not all embodiments include all steps of FIGS. 2-4 and one or more steps may be in a different order in some embodiments. Further, in some embodiments, the application process can take place at a variety of locations, using a variety of device including using a customer's device.

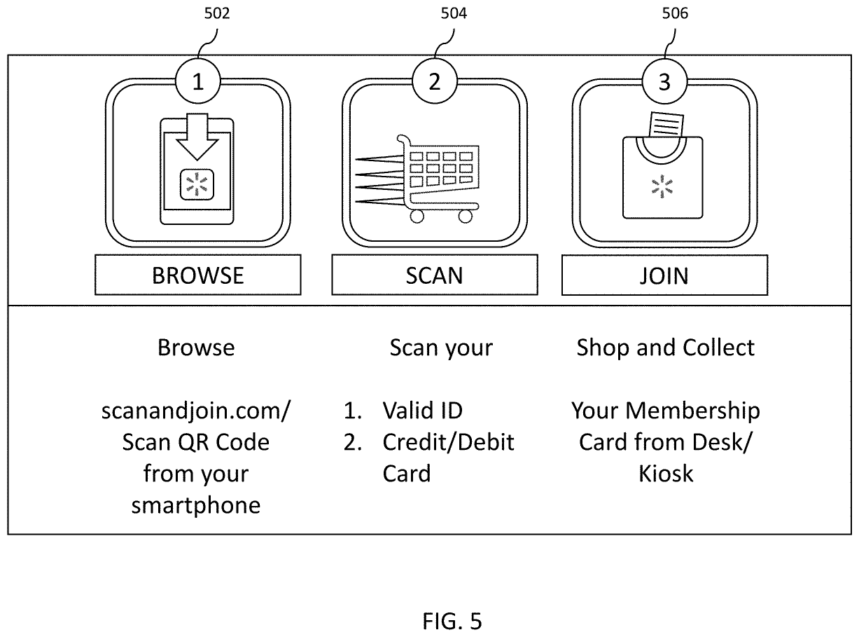

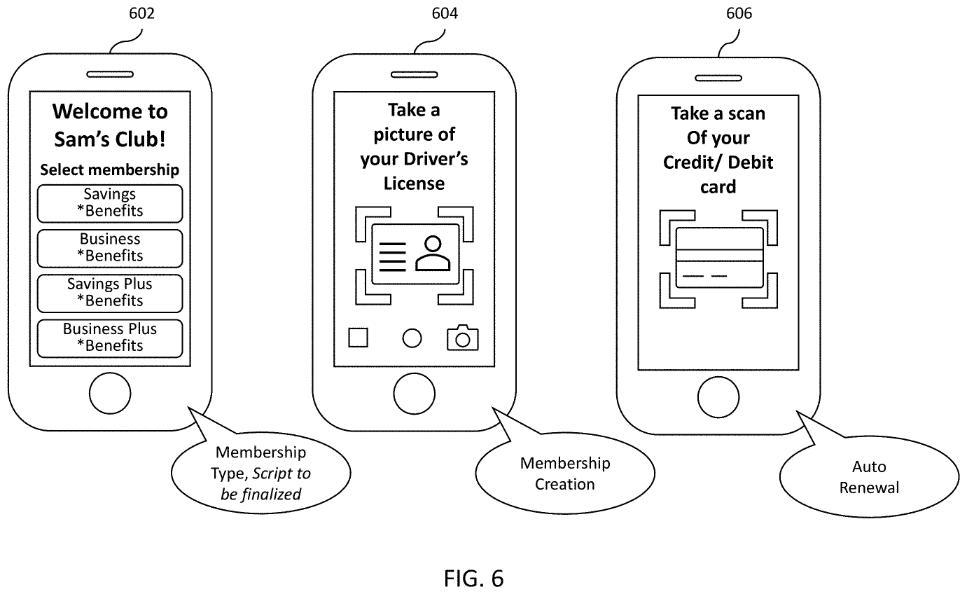

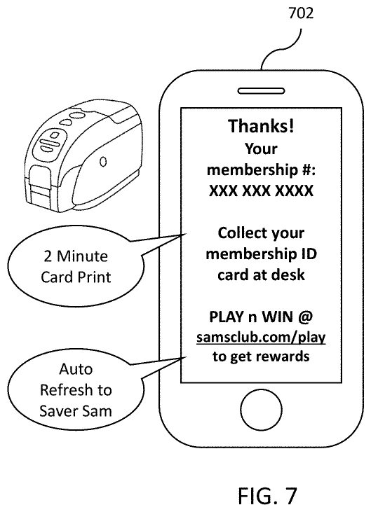

Referring next to FIGS. 5-7, flow diagrams are shown of an exemplary membership application process using a mobile user device according to some embodiments. In this illustration, a customer's (potential member's) electronic device is used for the application process. The user device may be running an application or may be accessing a website of the retailer. Initially, the user scans or reads a QR code which activates the application process on the app or website (502). See also, the sample display screen 602 of FIG. 6. The user is then prompted to scan an identification card and credit card for membership payment (504), see also the sample display screens 604 and 606 of FIG. 6. And once, processed, the user is informed that a membership card is available for pickup (506), e.g., from a desk or kiosk, see also the sample display screen 702 of FIG. 7. In some embodiments, scanning a credit card can make it easier for the member to enroll in auto-renew processes in some embodiments (see sample screen 606 in FIG. 6).

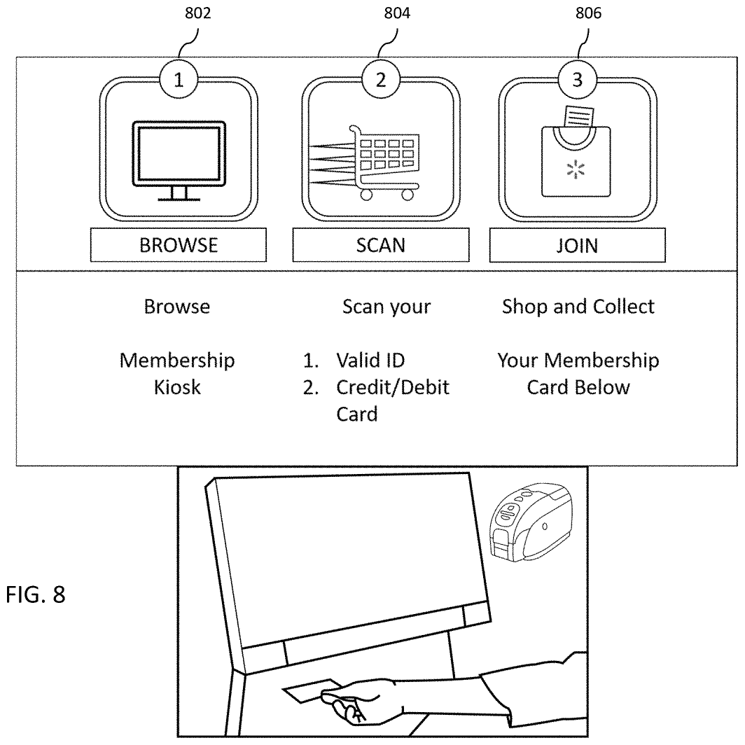

Referring next to FIG. 8, a flow diagram is are shown of an exemplary membership application process using at a kiosk according to some embodiments. In this illustration, an optical or electromagnetic scanner at a kiosk is used for the application process. Initially, the user selects the membership type (802). The user is then prompted to scan an identification card and credit card for membership payment (804). And once, processed, the user is informed that a membership card is available (806), e.g., output from the kiosk.

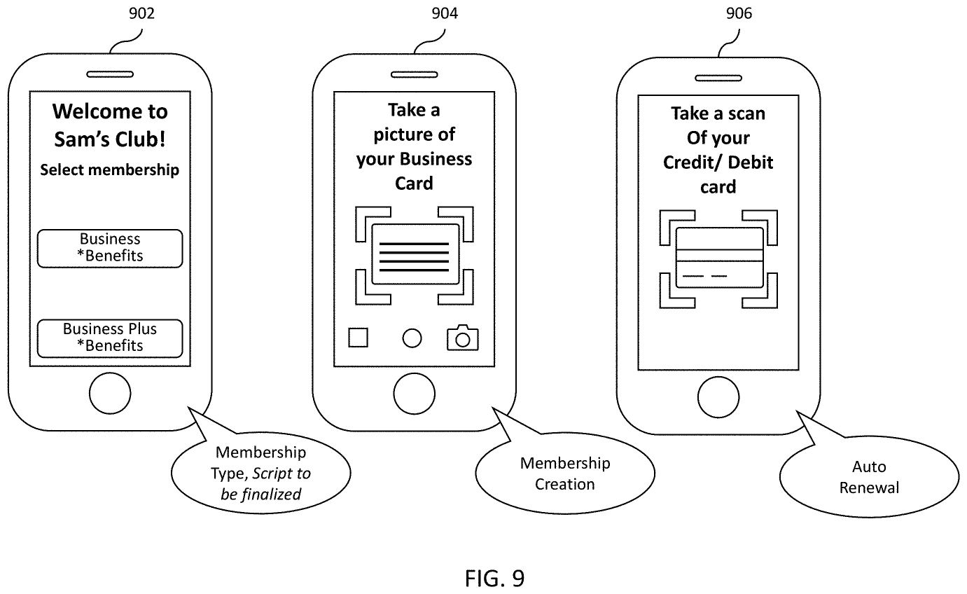

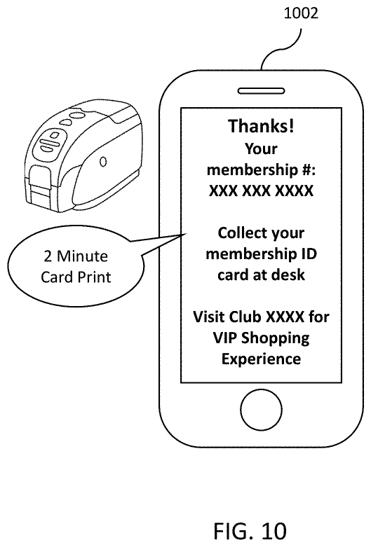

Referring next to FIGS. 9 and 10, flow diagrams illustrated by sample screen shots are shown of an exemplary enterprise membership application process according to some embodiments. In these embodiments, a business customer's (potential member's) electronic device is used for the application process. The user device may be running an application or may be accessing a website of the retailer. Initially, the user selects the business membership, see the sample display screen 902 of FIG. 9. The user is then prompted to scan an identification card (e.g., business card) and credit card for membership payment, see the sample display screens 904 and 906 of FIG. 9. And once, processed, the user is informed that a membership card is available for pickup, see the sample display screen 1002 of FIG. 10. In some embodiments, scanning a credit card can make it easier for the member to enroll in auto-renew processes in some embodiments.

Accordingly, in some embodiments, user device (user interface device 104) comprises one of: a retailer computing device operated a retailer employee; a self service kiosk operated the customer; a customer owned mobile computing device; a customer owned computing device and wherein the user interface is provided by a website of the retailer; and a customer owned computing device having a retailer application installed thereon and providing the user interface when executed.

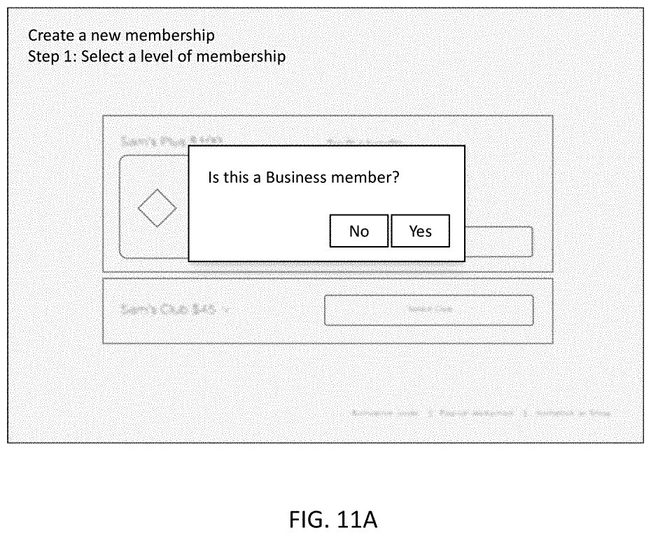

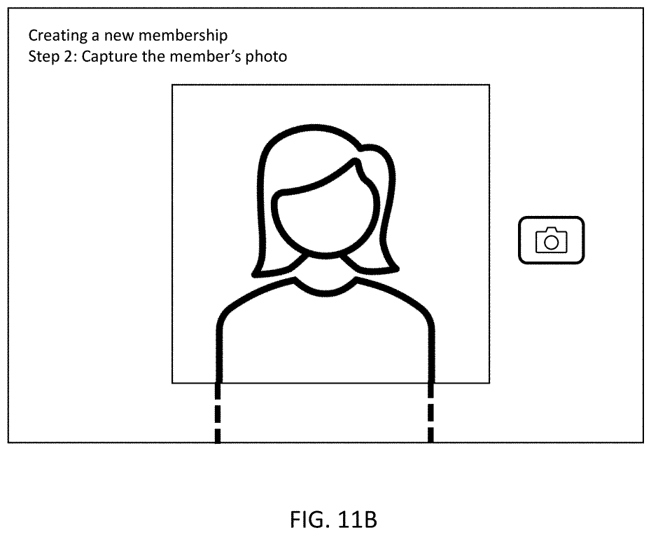

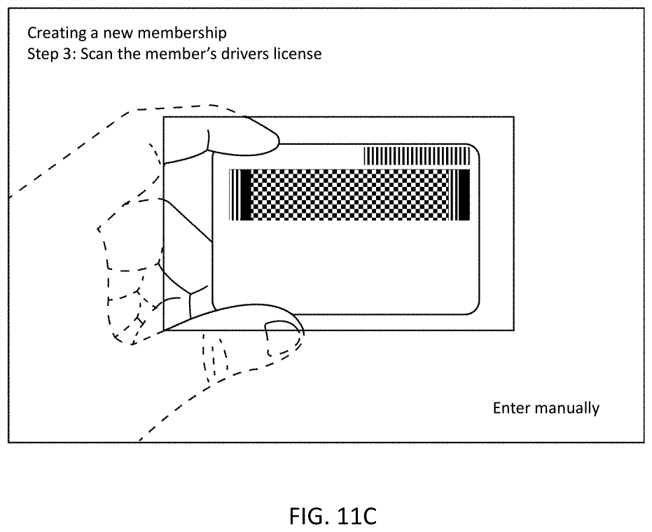

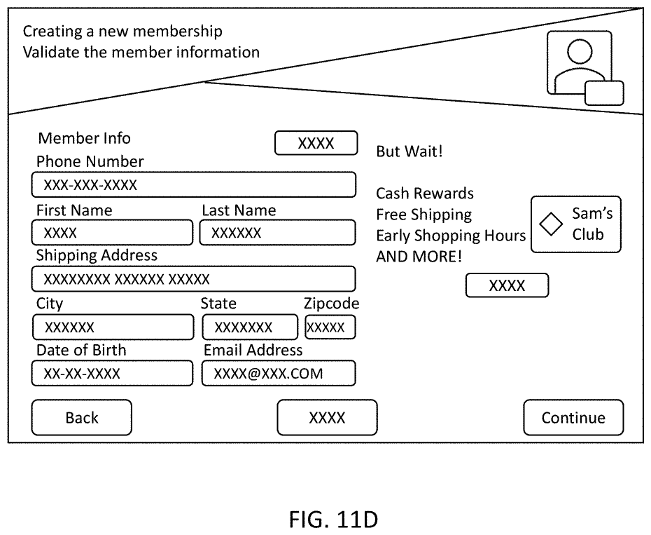

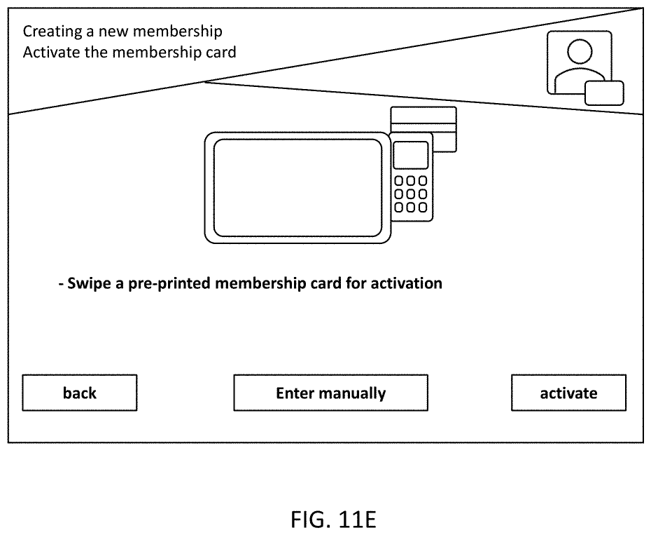

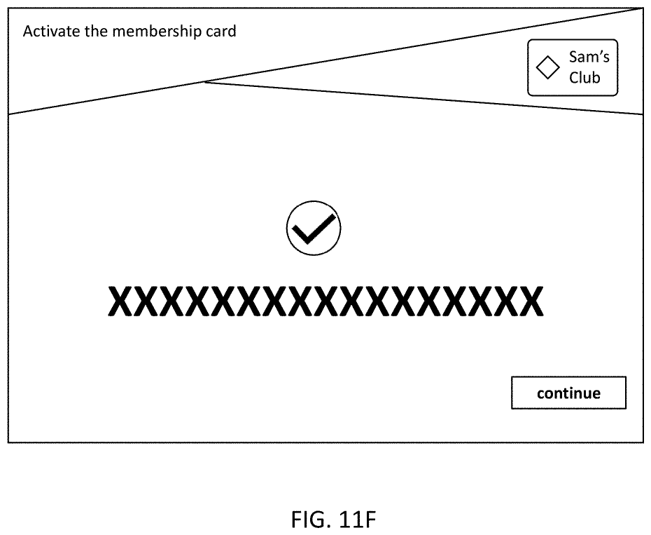

Referring next to FIGS. 11A-11F, exemplary screen shots are shown of exemplary membership application process according to some embodiments. In these embodiments, the application process is run on a computer of an employee of the retailer. In FIG. 11A, a selection is made whether the application is for a business member (see also 202 of FIG. 2). In FIG. 11B, an image of the customer/member is taken, e.g., by an image capture device 110a at the membership desk. In FIG. 11C, the user's identification card image is captured (or can be entered manually if a license from a restricted state). In some embodiments, the same image capture device used in FIG. 11B may be used in FIG. 11C. In FIG. 11D, the customer data obtained from the captured image is shown as being populated into the membership application form. The employee has the option to validate the data and continue or go back. In FIG. 11E, the employee is prompted to swipe the pre-printed membership card for activation and activate, go back or manually enter the card for activation. And in FIG. 11F, the approved and activated membership card number is illustrated. It is understood that FIGS. 11A-11F illustrate example steps and may be variously implemented in a variety of user devices, displays such as those described herein.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for membership application with a retailer, the system comprising:
a membership processing control circuit configured to process applications for membership and credit with the retailer, the retailer offering memberships allowing customers to be able to purchase products and receive benefits pertaining to membership;
a capture device coupled to the membership processing control circuit and configured to obtain an image of the customer and electronically scan data from a customer identification card for automatic population into an electronic membership application;
a user interface device comprising a display and an input device coupled to the membership processing control circuit, wherein the user interface device is configured to facilitate an application process; and
a retailer server coupled to the membership processing control circuit and configured to communicate with a financial institution server configured to process an electronic credit application received from the membership processing control circuit,
wherein the user interface device is configured to:
prompt the customer to pose for the capture device to obtain the image of the customer;
prompt the customer to present the customer identification card to the image capture device for automatic capturing of customer data from the customer identification card; and
prompt the customer to input additional data for the electronic credit application;
wherein the membership processing control circuit is configured to:
receive, from the capture device, the image of the customer and the customer data captured from the customer identification card;
populate the electronic membership application and the electronic credit application with the customer data and the additional data;
process the electronic membership application;
transmit the electronic credit application to the financial institution server via the retailer server;
receive data from the financial institution server via the retailer server indicating an acceptance and terms of a credit offer based on the electronic credit application; and
output to the user interface device an approval of the electronic membership application and the credit offer and the terms for presentation to the customer.

2. The system of claim 1 wherein the capture device comprises one or more of:
a reader comprising one or both of a radio frequency identification (RFID) and near field communication (NFC) reader configured to read the data from the customer identification card for automatic population into the electronic membership application; and
an image capture device.

3. The system of claim 1 wherein the customer identification card comprises a government issued card.

4. The system of claim 3 wherein the government issued card comprising one of a driver's license and a passport.

5. The system of claim 3 wherein a jurisdiction corresponding to a location of the membership application process includes a restriction limiting rights in electronically scanning data from the government issued card, and
wherein the user interface device is configured to output for display instructions to a user in order to comply with the restriction when the user interface device prompts the customer to present the government issued card to the capture device for the automatic capturing of the customer data from the government issued card.

6. The system of claim 1 wherein the customer identification card comprises a business card of the customer.

7. The system of claim 1 wherein the user interface device comprises one of:
a retailer computing device operated a retailer employee;
a self service kiosk operated the customer;
a customer owned mobile computing device;
a customer owned computing device and wherein the user interface is provided by a website of the retailer; and
a customer owned computing device having a retailer application installed thereon and providing the user interface when executed.

8. The system of claim 1 wherein the capture device is contained within a device separate and remote from the membership processing control circuit.

9. The system of claim 1 wherein the capture device is integrated into a device containing the membership processing control circuit.

10. The system of claim 1 wherein the membership processing control circuit is configured to output signaling to cause a membership card to be encoded for the customer.

11. The system of claim 10 wherein the membership processing control circuit is configured to cause the display of instructions for the customer on the user interface device to retrieve the membership card having been printed.

12. The system of claim 1 wherein the membership processing control circuit is configured to initiate a membership application process upon one of a customer scanning a code using the capture device, and a customer indicating an intent to apply for a membership.

13. The system of claim 1 wherein the membership processing control circuit is configured to prompt the customer to indicate on the user interface device whether the membership is to be a personal membership or a business membership.

14. The system of claim 13 wherein the membership processing control circuit is configured to prompt the customer via the user interface device to present a business card to the capture device for automatic capturing of customer business information.

15. The system of claim 1 wherein the membership processing control circuit is configured to communicate with the financial institution server via the interface to indicate whether the customer is eligible for a credit offer.

16. The system of claim 15 wherein the membership processing control circuit is configured to, in response to the customer indicating an interest in the credit offer, populate the electronic credit application and transmit the electronic credit application the financial institution server.

17. A method for membership application with a retailer, the method comprising:
prompting, using a user interface device comprising a display and an input device, a customer to pose for an image to be obtained by a capture device;
prompting, using the user interface device, the customer to present a customer identification card to the capture device;
automatically capturing, using the capture device, the image of the customer and customer data read from the customer identification card;
receiving, at a membership processing control circuit coupled to the user interface device and the capture device, the image of the customer and the customer data captured from the customer identification card, the membership processing control circuit configured to process applications for membership and credit with the retailer, the retailer offering memberships allowing customers to be able to purchase products and receive benefits pertaining to membership;
prompting the customer to input additional data for an electronic credit application using the user interface device;
populating an electronic membership application and the electronic credit application with the customer data and the additional data;
processing the electronic membership application;
transmitting the electronic credit application to a financial institution server via a retailer server coupled to the membership processing control circuit, wherein the financial server is configured to process the electronic credit application;
receiving data from the financial institution server via the retailer server indicating an acceptance and terms of a credit offer based on the electronic credit application; and
outputting to the user interface device an approval of the electronic membership application and the credit offer and the terms for presentation to the customer.

18. The method of claim 17 wherein the capture device comprises one or more of:
a reader comprising one or both of a radio frequency identification (RFID) and near field communication (NFC) reader configured to read the data from the customer identification card for automatic population into the electronic membership application; and
an image capture device.

19. The method of claim 17 wherein the user interface device comprises one of:
a retailer computing device operated a retailer employee;
a self service kiosk operated the customer;
a customer owned mobile computing device;
a customer owned computing device and wherein the user interface is provided by a website of the retailer; and
a customer owned computing device having a retailer application installed thereon and providing the user interface when executed.

20. The method of claim 17 wherein the customer identification card comprises a government issued card.
